(19) United States
(12) Patent Application Publication
(10) Pub. No.: US 2024/0240821 A1
(43) Pub. Date: Jul. 18, 2024

(54) CHILLER SYSTEM WITH INTELLIGENT CONTROL

(71) Applicant: Taiwan Semiconductor Manufacturing Co., Ltd., Hsinchu (TW)

(72) Inventors: Chih-Neng Chang, Hsinchu (TW); Tzu-Wei Chien, Hsinchu (TW); Chien-Wei Chen, Hsinchu (TW); Fu-Chun Chang, Hsinchu (TW); Kun-Hsien Tsai, Hsinchu (TW); Kai-Yuan Cheng, Hsinchu (TW)

(21) Appl. No.: 18/153,978

(22) Filed: Jan. 12, 2023

(51) Int. Cl. F24F 11/46; G05B 13/02

(52) U.S. Cl. CPC F24F 11/46; G05B 13/027

(57) ABSTRACT

A chiller system provides cooling for a semiconductor fabrication facility. The chiller system includes a control system. The control system utilizes one or more analysis models trained with a machine learning process to intelligently assist in reducing the power consumption and enhancing the efficiency of the chiller system.

### BACKGROUND

Many types of facilities utilize cooling systems to cool rooms, equipment, or machines. While traditional HVAC systems may be enough to cool homes or small businesses, larger facilities may utilize industrial chiller systems. Chiller systems, such as water-based chiller systems may utilize a condenser, an evaporator, and a compressor to transfer heat from a cooling load to water. The cooling load can be cooled in this manner.

Semiconductor fabrication facilities may have large scale cooling needs. For example, the semiconductor fabrication facilities may utilize precise ambient temperatures in clean rooms, wafer storage facilities, and other areas of the facilities. Furthermore, semiconductor fabrication facilities may utilize cooling for semiconductor processing equipment such as deposition chambers, etching chambers, furnaces, photolithography systems, dopant implantation systems, laser systems, and other types of systems.

In some cases, chiller systems may account for up to 20% of the total power consumption of a semiconductor fabrication facility. In many industries, there are efforts being made to achieve net zero carbon emissions. In order to accomplish this, it is beneficial to reduce the power consumption of chiller systems.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of a system, in accordance with some embodiments.

FIG. 2 is a block diagram of a system, in accordance with some embodiments.

FIG. 3 is a block diagram of a control system, in accordance with some embodiments.

FIG. 4A is a flow diagram of a process for operating a control system for a chiller system, in accordance with some embodiments.

FIG. 4B, includes a graph illustrating principles of a polynomial regression model, in accordance with some embodiments.

FIG. 4C is a graph illustrating predicted and measured power consumption of a chiller system, in accordance with some embodiments.

FIG. 5 is a flow diagram of a process for operating a chiller system, in accordance with some embodiments.

FIG. 6 is a flow diagram of a process for operating a chiller system, in accordance with some embodiments.

FIG. 7 is a flow diagram of a process for operating a chiller system, in accordance with some embodiments.

FIG. 8 is a flow diagram of a process for operating a chiller system, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, certain specific details are set forth in order to provide a thorough understanding of various embodiments of the disclosure. However, one skilled in the art will understand that the disclosure may be practiced without these specific details. In other instances, well-known structures associated with electronic components and fabrication techniques have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second and third does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least some embodiments. Thus, the appearances of the phrases “in one embodiment”, “in an embodiment”, or “in some embodiments” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Embodiments of the present disclosure provide a control system for a chiller system that utilizes machine learning techniques to reduce the power consumption and improve the overall efficiency of the chiller system. A chiller system may include multiple closed fluid circulation loops. The chiller control system includes a plurality of sensors that sense temperatures and pressures at various locations internal to and external to the chiller system. The chiller control system includes one or more analysis models trained with a machine learning process to predict operating adjustments to reduce the power consumption of the chiller system based on the sensed pressures, temperatures, cooling loads, and compressor loads. In this way, the chiller control system can continually and intelligently adjust operating conditions to reduce power consumption.

In some embodiments, a machine learning trained analysis model can predict the power consumption of the chiller system and can compare the predicted power consumption to real time power consumption data. If there is a significant difference in the predicted power consumption and the real time power consumption data, then the analysis model can output an alert that one or more components of the chiller system should be checked and serviced.

In some embodiments, a machine learning trained analysis model can predict the energy consumption for different numbers of parallel connected chiller systems based on cooling needs and other factors. If the analysis model determines that a different number of operating chiller systems will provide better energy efficiency, then the analysis model can output an alert indicating the number of chiller systems that should be put in operation.

In some embodiments, a machine learning trained analysis model can predict which operational parameters should be adjusted in order to produce improved energy efficiency. For example, the analysis model may receive temperature, pressure, flow rate, and current power consumption parameters and may output one or more suggested parameter adjustments. The suggested parameter adjustments can then be applied to the chiller system in order to improve energy efficiency. A control system may automatically adjust parameters based on the output of the analysis model.

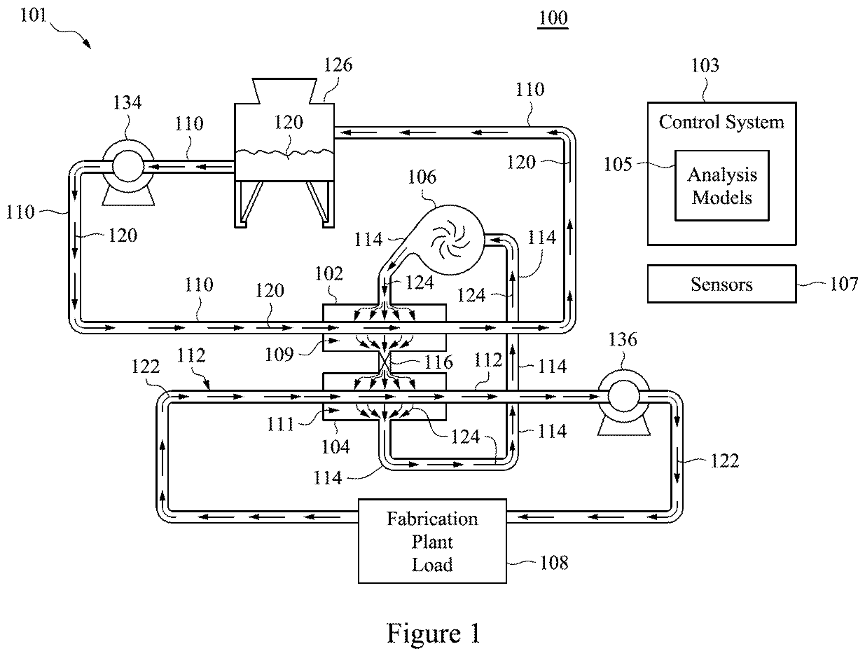

FIG. 1 is an illustration of a system 100, in accordance with some embodiments. The system 100 includes a chiller system 101 configured to cool a load 108. As will be set forth in more detail below, the system 100 includes a control system 103 that utilizes one or more analysis models 105 trained with a machine learning process to improve the efficiency of the chiller system 101.

In some embodiments, the chiller system 101 is implemented at a semiconductor fabrication facility. The semiconductor fabrication facility may process semiconductor wafers in order to form integrated circuits within the semiconductor wafers. Processing of the semiconductor wafers may include performing a large number of processing steps such as thin-film depositions, etching processes, epitaxial growth processes, annealing processes, dopant implantation processes, photolithography processes, planarization processes, wafer transfer processes, wafer storage processes, and other types of processes.

Wafer storage, transfer, and processing processes may be highly sensitive to temperature. Accordingly, it may be beneficial to keep the temperature of fabrication rooms, storage rooms, transfer systems, within tight ranges. Furthermore, it may be beneficial to cool deposition equipment, etching equipment, photolithography equipment, laser equipment, furnaces, and other types of processing tools and equipment.

The system 100 utilizes the chiller system 101 in order to perform the cooling functions described above. While FIG. 1 illustrates a single chiller system 101, the system 100 may include a plurality of chiller systems that can be selectively enabled and disabled depending on the cooling needs of the fabrication facility. Due to the large cooling needs of the semiconductor fabrication facility, operation of the one or more chiller systems 101 may represent up to 20% of the power consumption of the semiconductor fabrication facility.

The system 100 utilizes the control system 103 to help intelligently improve the energy efficiency of the one or more chiller systems 101. The control system 103 includes one or more analysis models 105. The analysis models 105 are each trained with a machine learning process to intelligently monitor or control aspects of the chiller system in order to promote efficient operation of the chiller systems 101 while meeting the cooling needs of the semiconductor fabrication facility. While embodiments herein may primarily describe a chiller system 101 implemented at a semiconductor fabrication facility, in practice, principles of the present disclosure can extend to any other type of facility that utilizes chiller systems. Accordingly, chiller systems implemented in such other types of facilities fall within the scope of the present disclosure.

Prior to discussing further details of the control system 103 of the analysis model 105, it is beneficial to describe operational features of the chiller system 101. For the remainder of the description of FIG. 1, a single chiller system 101 will be described. However, it should be noted that the system 100 may include multiple chiller systems 101 operating in parallel.

The chiller system 101 includes a condenser 102, an evaporator 104, and a compressor 106. The condenser 102 includes an interior volume 109. The evaporator 104 includes an interior volume 111. Further details regarding the operation of the condenser 102, the evaporator 104, and the interior volume 109 will be provided further below.

The chiller system 101 includes multiple closed-loop fluid circulation systems. A first closed-loop fluid circulation system is a cooling water circulation system that includes a cooling water pipe 110. The cooling water pipe 110 carries cooling water 120. The first closed-loop fluid circulation system includes a cooling tower 126. The cooling water 120 flows from the cooling tower 126 to a pump 134. The pump 134 may be described as a condenser pump. The pump 134 drives circulation of the cooling water 120 through the pipe 110 back to the cooling tower 126.

The cooling water pipe 110 extends through the interior volume 109 of the condenser 102. However, the cooling water pipe 110 protects the cooling water 120 from direct exposure to the interior volume 109. In other words, the cooling water 120 is never outside the pipe 110 in the internal volume 109 of the condenser 102. The function of the cooling water circulation system and the condenser 102 will be described in greater detail below. FIG. 1 labels the cooling water pipe 110 with a single reference number. However, the cooling water circulation system may include multiple sections of pipe 110 coupled together and extending between components of the cooling water circulation system in order to form a complete closed-loop circulation system.

A second closed-loop fluid circulation system of the chiller system 101 is a chilled water circulation system. The chilled water circulation system includes a chilled water pipe 112. The chilled water pipe 112 carries chilled water 122. The chilled water circulation system includes a chilled water pump 136 that drives circulation of the chilled water 122 through the chilled water pipe 112.

The chilled water pipe 122 passes from the chilled water pump 136 to the fabrication plant load 108. Though not shown in FIG. 1, the chilled water pipe 122 may pass through exchanger equipment, such as an air handling unit or other equipment that interacts with the fabrication plant load 108.

The chilled water pipe 122 extends from the fabrication plant load 108 into the interior volume 111 of the evaporator 104. The chilled water pipe 112 protects the chilled water 122 from direct exposure to the interior volume 111 of the evaporator 104. In other words, the chilled water 122 is never outside the pipe 112 within the interior volume 111 of the evaporator 104. FIG. 1 labels the chilled water pipe 112 of a single reference number. However, the chilled water circulation system may include multiple sections of pipe 112 coupled together and extending between components of the chilled water circulation system in order to form a complete closed-loop circulation system.

A third closed-loop fluid circulation system of the chiller system 101 is the refrigerant circulation system. The refrigerant circulation system includes a refrigerant pipe 114. A compressor 106 drives circulation of a refrigerant fluid 124 through the refrigerant pipe 114. The refrigerant pipe 114 empties directly into the interior volume 109 of the condenser 102 such that the refrigerant fluid 124 contacts the exterior surface of the cooling water pipe 110 within the interior volume 109 of the condenser 102.

In some embodiments, the refrigerant circulation system includes an expansion valve 116 coupled between the interior volume 109 of the condenser 102 and the interior volume 111 of the evaporator 104. Though not shown in FIG. 1, sections of refrigerant pipe 114 may be coupled between the outlet of the interior volume 109 and the inlet of the expansion valve 116. Though not shown in FIG. 1, sections of the refrigerant pipe 114 may be coupled between the outlet of the expansion valve 116 and the inlet of the interior volume 111 of the evaporator 104.

The refrigerant fluid flows from the interior volume 109 through the expansion valve 116 and into the interior volume 111 of the evaporator 104. The refrigerant fluid 124 contacts the exterior surface of the chilled water pipe 112 within the interior volume 111 of the evaporator 104. The refrigerant pipe 114 carries the refrigerant 124 from the outlets of the internal volume 111 of the evaporator 104 to the inlet of the compressor 106. The compressor 106 compresses the refrigerant fluid 124 and drives circulation of the refrigerant fluid 124.

The pipe 114 that carries the refrigerant fluid 124 from the compressor 106 to the condenser 102 and from the evaporator 104 back to the compressor 106 is labeled as a single pipe. However, in practice, the pipe 114 includes a plurality of discrete sections coupled together and coupled between the other components of the refrigerant circulation system to form a complete closed-loop refrigerant circulation system.

The evaporator 104 has the effect of chilling the chilled water 122. As the chilled water 122 passes through the section of pipe 112 within the interior volume 111 of the evaporator 104, heat is transferred via the refrigerant fluid 124 from the chilled water 122. Further details regarding the transfer of heat will be described in relation to the refrigerant circulation system. The chilled water 122 that leaves the evaporator 111 has a temperature T1. In general, the temperature T1 is the lowest temperature of the chilled water 122 within the chilled water circulation system. In one embodiment. T1 is between 3° C. and 8° C., though other temperatures can be utilized without departing from the scope of the present disclosure.

The pump 136 then forces the chilled water through the pipe 112 to the fabrication plant load 108, or rather to systems that transfer heat from the fabrication plant load 108 to the chilled water 122. Heat from the fabrication plant load 108 is transferred into the chilled water 122, thereby raising the temperature of the chilled water 122 to a temperature T2. The temperature T2 is higher than the temperature T1. In some embodiments, the temperature T2 is between 10° C. and 15° C., though other temperatures can be utilized without departing from the scope of the present disclosure.

The chilled water 122 then circulates through the pipe 112 back to the evaporator 104. Accordingly, the chilled water 122 enters the evaporator 104 at temperature T2. The refrigerant fluid 124 transfers heat from the chilled water 122 within the evaporator 104. The chilled water 122 then exits the evaporator at temperature T1.

The condenser 102 has the effect of heating the cooling water 120. In particular, as the cooling water 120 passes through the section of pipe 110 within the interior volume 109 of the condenser 102 heat is transferred from the refrigerant fluid 124 to the cooling water 120 within the condenser 102. The cooling water 120 exits the condenser 102 at a temperature T3. T3 is greater than T2. In some embodiments, the temperature T3 is between 29° C. and 35° C., though other temperatures can be utilized without departing from the scope of the present disclosure. The cooling water 120 flows through the pipe 110 into the interior volume of the cooling tower 126.

The cooling tower 126 cools the cooling water 120. In some embodiments, the cooling tower 126 is positioned external to a building in the outside environment. For example, the cooling tower 126 may be positioned on a roof of a building or in some other external location. In some embodiments, the cooling tower 126 is positioned within a building. In any case, the temperature of the cooling water 120 drops within the cooling tower 126. The cooling water 120 exits the cooling tower into the cooling water pipe 110 at a temperature T4. Temperature T4 is lower than the temperature T3. In some embodiments, the temperature T4 is between 25° C. and 29° C., though other temperatures can be utilized without departing from the scope of the present disclosure.

In some embodiments, the compressor 106 compresses the refrigerant fluid 124 and drives the refrigerant fluid 124 through the pipe 114. When the refrigerant fluid exits the compressor 106, the refrigerant fluid may be in a high temperature, high pressure gaseous state. The refrigerant fluid 124 exchanges heat with the pipe 110, thereby heating the cooling water 120. Within the condenser 102, the refrigerant fluid condenses from a high pressure gaseous state to a high pressure liquid state.

The refrigerant fluid 124 then passes from the interior volume 109 of the condenser 102 through the expansion valve 116. The expansion valve restricts the flow of the refrigerant fluid 124 from the condenser 102 into the evaporator 104. This reduces the pressure of the refrigerant 124 and allows expansion of the refrigerant fluid 124 back to the gaseous or vapor phase at a much lower temperature.

The refrigerant fluid 124 may enter the evaporator 104 in both a liquid state and gaseous state. When the refrigerant fluid 124 enters the evaporator 104 the refrigerant fluid 124 is at a very low temperature. Within the evaporator, heat is transferred from the chilled water 122 to the refrigerant fluid 124, thereby cooling the chilled water 122 to the temperature T1 and heating the refrigerant fluid 124. This causes complete evaporation of the refrigerant fluid 124. The refrigerant fluid 124 then passes to the compressor 106 at a moderate temperature and in a gaseous phase.

As described previously, because a semiconductor facility (or other type of facility) may have very large cooling needs, the chiller system 111 may consume relatively large amounts of power. In order to reduce power consumption, it is beneficial to operate chiller system 111 in an efficient manner.

Various factors affect the overall power consumption and efficiency of the chiller system 111. The compressor 106 may be the largest power consumer in the chiller system 101. However, other power consumers can include fluid pumps such as the cooling water fluid pump 134 and the chilled water fluid pump 136, air handling units, sensors, valve activators, control systems, and other aspects of the chiller system 101.

Furthermore, various operating parameters of the chiller system can affect the overall efficiency and power consumption of the chiller system 101. For example, the amount of heat removed by the chiller system per unit time is one operating parameter of the chiller system 101. Typically, refrigeration is measured in refrigeration tons corresponding to the amount of heat removed by a chiller system that will melt 1 ton of ice in 24 hours. One refrigeration ton is approximately equal to 3.52 kW. The evaporation pressure of the refrigerant fluid 124, the condensing pressure of the refrigerant fluid 124, the number of running chiller machines, the temperature and enthalpy of outside air, the temperature (T1) of the chiller water 122, the temperature (T2) of the chiller water 122, the chiller water flow rate, the outsider and faulty, the chiller water pressure, the cooling water temperature (T3), the cooling water temperature (T4), the cooling water flow rate, and the cooling water pressure, are other operating parameters.

The chiller system 101 includes a plurality of sensors 107 to monitor the operating parameters of the chiller system 101. The sensors 107 can include a temperature sensor for the chiller water 122 exiting the evaporator 104, a temperature sensor for the chiller water 122 entering the evaporator 104, one or more pressure sensors for the chiller water 122, and one or more flow rate sensors for the chiller water 122. The sensors 107 can include a pressure sensor for the refrigerant fluid 124 in the condenser 102, a pressure sensor for the refrigerant fluid in the evaporator 104, one or more flow rate sensors for the refrigerant fluid 124, and one or more power consumption sensors or monitors for the compressor 106. The sensors 107 can include one or more power consumption sensors for other aspects of the chiller system 101. The sensors 107 can include one or more pressure sensors, temperature sensors, and flow rate sensors for the expansion valve 116. The sensors 107 can include one or more temperature sensors configured to sense the temperature of the outside environment, one or more temperature sensors for the water tower 126, a temperature sensor for the cooling water 122 exiting the condenser 102, a temperature sensor for the cooling water 122 entering the condenser 102, one or more pressure sensors for the cooling water 122, and one or more flow rate sensors for the cooling water 122. The sensors 107 can include other sensors than those described herein without departing from the scope of the present disclosure. The sensors 107 can be positioned in appropriate locations to measure their respective parameters. Each of the sensors 107 can output sensor signals indicative of the values of their sense parameters.

The control system 103 can be communicatively coupled to the sensors 107. The control system 103 can receive the sensor signals from the sensors 107. The control system 103 can receive the sensor signals via wired connections or wireless connections. The chiller system 101 can include communication, processing, and memory resources for routing the sensor signals from each of the sensors 107 to the control system 103.

The control system 103 is configured to control the operation of the various components of the chiller system 101. Accordingly, the control system 103 can be communicatively coupled to each of the components of the chiller system 101. The control system 103 can send control signals to the components of the chiller system 101 in order to activate operations of the components, stop operation of the components, pause operation of the components, adjust operational parameters of the components, or to perform other actions.

The control system 103 can also receive data related to the fabrication plant load 108. For example, the control system 103 can receive data indicating the total cooling load from moment to moment. The control system 103 can include data indicating which rooms or storage areas of the facility the cooling, which process tools need cooling, and any other equipment or aspects of the facility that the cooling. The control system 103 can receive data indicating the amount of cooling needed by each of these locations or equipment.

The control system 103 includes one or more analysis models 105. Each of the analysis model 105 is trained with a machine learning process to perform a function related to monitoring or improving the power consumption or overall efficiency of the chiller system 101. Further details regarding machine learning processes are described below.

In some embodiments, the control system 103 includes an analysis model configured to diagnose abnormal energy consumption of the chiller system 101. This can include predicting the power consumption of the chiller system 101 based on a plurality of input parameters. The input parameters can include the refrigeration ton, refrigerant evaporation pressure, refrigerant condensing pressure, the power consumption of the compressor 106, or other parameters.

The analysis model 105 can compare the predicted power consumption with real time power consumption data received from power consumption sensors. If the predicted power consumption differs from the real time power consumption by the amount larger than a threshold amount, then the analysis model 105 can output an alert indicating that components of the chiller system 101 should receive examination for errors and possibly should receive maintenance. If errors or malfunctions are found in components of the chiller system 101, then maintenance can be performed to return the chiller system 101 proper functioning. This can result in a large amount of power savings over time and can improve the overall efficiency of the chiller system 101. Further details regarding such an analysis model 105 and process, are provided further below.

In some embodiments, the control system 103 can include an analysis model 105 that predicts the total power consumption and average load current from running different numbers of chiller systems 101. The total power consumption and load current for running a particular number of chiller systems can be affected by a large number of parameters. The analysis model 105 can receive a large number of operating parameters as input data and can output a predicted power consumption and predicted load current for different numbers of chiller systems 101 operating in parallel. The input parameters can include the number of running chiller machines, the refrigeration ton, outside air enthalpy, chiller water supply temperature, chiller water return temperature, chilled water flow rate, compressor power consumption, or other parameters. The analysis model 105 can predict the total power consumption and average load current for each of a plurality of different numbers of chiller systems. The analysis model can then identify the number of operating chiller machines that results in the lowest power consumption and/or the lowest average load current. The analysis model 105 can either cause the control system 103 to automatically operate the indicated number of chiller systems 101, or can output an indication to a technician that can manually interface with the control system 103 to activate the indicated number of chiller systems 101.

In some embodiments, the control system 103 can include an analysis model 105 configured to receive a plurality of chiller system operating parameters and to output parameter adjustment data indicating one or more parameters to be adjusted to reduce the power consumption of the chiller system 101. For example, the input parameters can include the refrigeration ton, outside air enthalpy, chilled water supply temperature, chilled water return temperature, chilled water flow rate, the power consumption of the chiller compressor, or other parameters. The analysis model 105 can then output parameter adjustment data including a recommended pressure difference for the chilled water pipe 110, a recommended chilled water temperature, a recommended temperature difference for the cooling water, a recommended temperature for the cooling water, or other parameters. The control system 103 can automatically implement the recommended adjustments or can output an alert for a technician to adjust the recommended parameters.

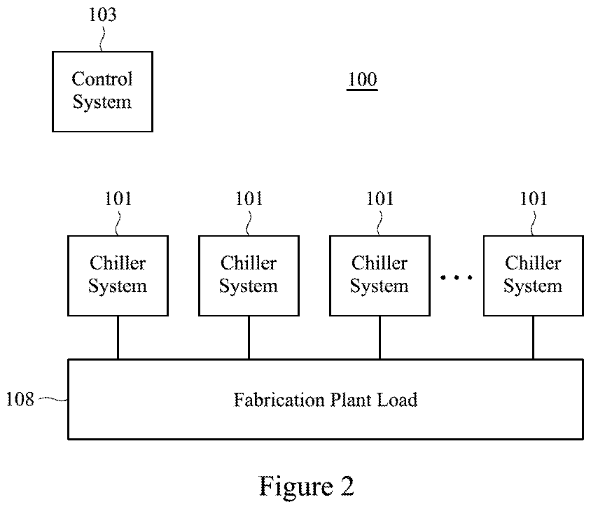

FIG. 2 is a block diagram of a system 100, in accordance with some embodiments. The system 100 includes a plurality of chiller systems 101 connected in parallel to a fabrication plant load 108. Each of the chiller systems 101 can correspond to the chiller system 101 described in relation to FIG. 1. The fabrication plant load can correspond to the fabrication plant load described in relation to FIG. 1. The control system 103 can correspond to the control system 103 described in relation to FIG. 1. Though not shown in FIG. 2, each of the chiller systems 101 can include a plurality of sensors 107 that provide sensor data to the control system 103 as described in relation to FIG. 1. The control system 103 can include one or more machine learning trained analysis models as described in relation to FIG. 1.

The control system 103 is configured to selectively activate or deactivate each of the chiller systems 101. For example, an analysis model 105 may indicate that three operational chiller systems 101 will result in a lowest power consumption. The control system 103 can selectively turn on or turn off each of the chiller systems 101 to result in three operational chiller systems. Furthermore, the control system 103 can adjust operating parameters of each of the operating chiller systems 101 in accordance with the output of one or more of the analysis models 105.

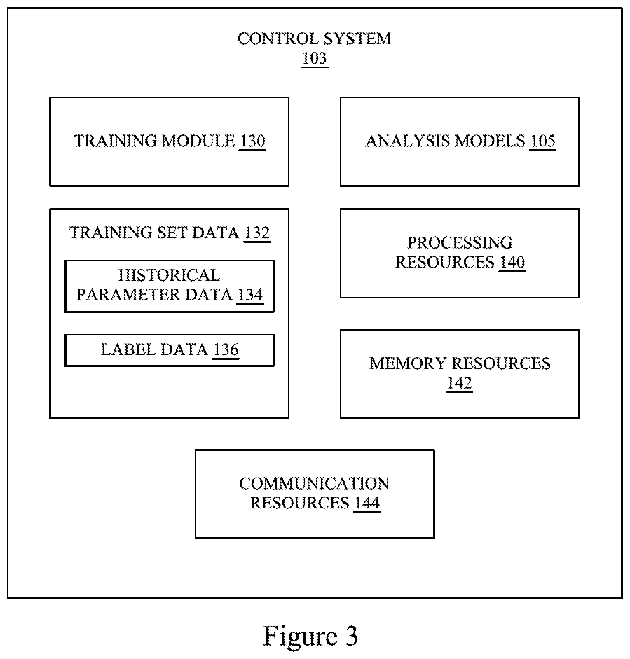

FIG. 3 is a block diagram of the control system 103 of FIG. 1, in accordance with some embodiments. The control system 103 of FIG. 3 is one example of a control system 103 of FIGS. 1 and 2. The control system 103 is configured to control one or more chiller systems 101

In one embodiment, the control system 103 includes one or more analysis models 105 and a training module 130. The training module 130 trains the analysis model 105 with a machine learning process. The machine learning process trains each analysis model 105 to generate prediction data related to the control systems 101 based on one or more input parameters associated with operation of the control systems 101.

The control system 103 includes, or stores, training set data 132 for each analysis model 105. The training set data 132 includes historical parameter data 134 and label data 136. The historical parameter data 134 includes a plurality of sets of previously recorded parameter data. Each set of previously recorded parameter data corresponds to data related to operational parameters or conditions of one or more chiller systems 101 data collected for a particular period of time or a particular instance in time. The label data 136 includes a label for each set of parameter data in the historical sensor data.

The types of parameters in the historical parameter data 134 and the type of label from the label data 136 depends on the type of analysis model 105 been trained. In other words, if the analysis model 105 has been trained to generate a type of prediction based for a chiller system 101 on a particular set of operational parameters associated with the chiller system 101, then each label will correspond to the type of prediction, and each set of historical parameter data will include the set of operational parameters on which the prediction will be based.

In one example, an analysis model 105 is to be trained to generate a predicted total power consumption based on refrigeration ton, refrigerant evaporation pressure, refrigerant condensing pressure, and the power consumption of the compressor. In this case, each set of parameter data from the historical parameter data 134 will include a refrigeration ton, a refrigerant evaporation pressure, a refrigerant condensing pressure, and a power consumption of the compressor associated with a chiller system for a particular moment or period of time. Each label from the label data 136 will include the total power consumption of the chiller system for that particular moment or period of time. The training set data 132 can include historical parameter data 134 for very large number of moments or periods of time under a large variety of operating conditions. The label data 136 will include a label for each of the number of moments or periods of time. Accordingly, the training set data 132 can be gathered by big data mining from a vast store of historical data associated with chiller systems that have previously operated.

In one embodiment the analysis model 105 includes a neural network. Training of the analysis model 105 will be described in relation to a neural network. However, other types of analysis models or algorithms can be used without departing from the scope of the present disclosure. The training module 130 utilizes the training set data 132 to train the neural network with a machine learning process. During the training process, the neural network receives, as input, the historical parameter data 134 from the training set data. During the training process, the neural network generates a predicted power consumption for each sensor data set from the historical parameter data 134.

During training, the control system 103 compares, for each set of parameter data from the historical parameter data 134, the predicted power consumption to the actual power consumption from the label data 136. The control system generates an error function indicating how closely the predicted power consumptions match the label data 136. The control system 103 then adjusts the internal functions (weighting values) of the neural network. Because the neural network generates predicted power consumptions based on the internal functions, adjusting the internal functions will result in the generation of different predicted power consumptions for a same set of parameter data. Adjusting the internal functions can result in predicted power consumptions that produces larger error functions (worse matching to the historical parameter data 134) or smaller error functions (better matching to the historical parameter data 134).

After adjusting the internal functions of the neural network, the historical parameter data 134 is again passed to the neural network and the analysis model 105 again generates predicted power consumptions. The training module 130 again compares the predicted power consumptions to the label data. The training module 130 again adjusts the internal functions of the neural network. This process is repeated in a very large number of iterations of monitoring the error functions and adjusting the internal functions of the neural network until a set of internal functions is found that results in predicted power consumptions that match the label data 136 across the entire training set.

At the beginning of the training process, the predicted power consumptions likely will not match the label data 136 very closely. However, as the training process proceeds through many iterations of adjusting the internal functions of the neural network, the errors functions will trend smaller and smaller until a set of internal functions is found that results in predicted power consumptions that match the label data 136. Identification of a set of internal functions that results in predicted power consumptions that match the label data 136 corresponds to completion of the training process.

An example of a neural network has been described above. However, other types of analysis models can be utilized. For example, a polynomial regression model can be utilized to generate predicted power consumption based on the input operating parameters. The polynomial regression model can be trained in a machine learning process utilizing the training set data 132 to generate predicted power consumption based on the selected operational parameters. The training process can be substantially similar, but with a polynomial regression model rather than a neural network. Various types of analysis models other than neural networks and polynomial regression models for an analysis model 105 can be utilized without departing from the scope of the present disclosure.

In some embodiments, the machine learning process trains an analysis model 105 generate a predicted power consumption based on a number of parallel operating chiller systems 101. In this case, the historical parameter data 134 includes sets of operating parameters for each of a plurality of moments or periods of time, as described previously. However, the historical parameter data 134 includes sets of operating parameters for each possible number of parallel operating chiller systems. If there are three available parallel operating chiller systems, then the historical parameter data 134 includes sets of operational parameters for situations in which one chiller system is operating, for situations in which two chiller systems are operating, and for situations in which three chiller systems are operating. In this case, the label data 136 includes the total power consumption for each set of historical operational parameters. In one example, the operational parameters include refrigeration time, outside air enthalpy, chilled water supply temperature, chilled water return temperature, chilled water pipe flow rate, power consumption of the chiller compressor, numbers of running chiller machines, or other operational parameters.

The machine learning process can utilize the training set data 132 to train the analysis model 105 to generate a predicted power consumption for each possible number of operating chiller systems, as described above. The analysis model 105 can include one or more of a neural network, a decision tree model, a linear regression model, a polynomial regression model, or other types of models.

In some embodiments, the analysis model 105 can be trained to predict both the total predicted power consumption and the average load current for each of a plurality of possible members of operating chiller systems. The analysis model 105 may include a first model or set of models that generates the predicted total power consumption for the various possible numbers of different chiller systems. A second model or set of models can be utilized to generate a predicted average load current for the different numbers of operating chiller systems. In this case, the label data 136 can include both power consumption data and the average load current data for a large number of moments of time or periods of time.

In one embodiment, the control system 103 can train an analysis model 105 to generate a set of recommended operating parameter adjustments for a chiller system to result in reduced power consumption. In this case, the historical parameter data can include the desired set of input parameters such as refrigeration time, outside air enthalpy, chilled water supply temperature (T1), chilled water return temperature (T2), chilled water flow rate, chilled water pressure, cooling water temperature (T3 and/or T4), cooling water flow rate, cooling water pressure, the pressure difference at an end of the chilled water pipe, or other parameters. The label data 136 can include the total power consumption.

The training process for the analysis model 105 may train a first sub-model of the analysis model 105 to generate predicted power consumption data as described above. The analysis model may also include a grid search algorithm that adjusts input parameter values of the first sub-model in iterations to obtain a set of input parameter values that results in a low total power consumption of the chiller system. The analysis model 105 at the outputs a recommended set of input parameter adjustments corresponding to the identified parameter values that resulted in low predicted total power consumption. In one example, the adjusted parameters can include a pressure difference at an end of the chilled water pipe 112, a recommended chilled water temperature (T1), a recommended temperature difference (T3−T4) of the cooling water 120, or other recommended adjusted temperature, pressure, flow rate values.

In one embodiment, the control system 103 includes processing resources 140, memory resources 142, and communication resources 144. The processing resources 140 can include one or more controllers or processors. The processing resources 140 are configured to execute software instructions, process data, perform signal processing, read data from memory, write data to memory, and to perform other processing operations.

In one embodiment, the memory resources 142 can include one or more computer readable memories. The memory resources 142 are configured to store software instructions associated with the function of the control system 103 and its components, including, but not limited to, the analysis models 105. The memory resources 142 can store data associated with the function of the control system 103 and its components. The data can include the training set data 132, sensor data, and any other data associated with the operation of the control system 103 or any of its components.

In one embodiment, the communication resources can include resources that enable the control system 103 to communicate with components of the chiller system 101 and with external systems. For example, the communication resources 144 can include wired and wireless communication resources that enable the control system 103 to receive the sensor data and to communicate with external systems. In one embodiment, the analysis models 105 are implemented via the processing resources 140, the memory resources 142, and the communication resources 144.

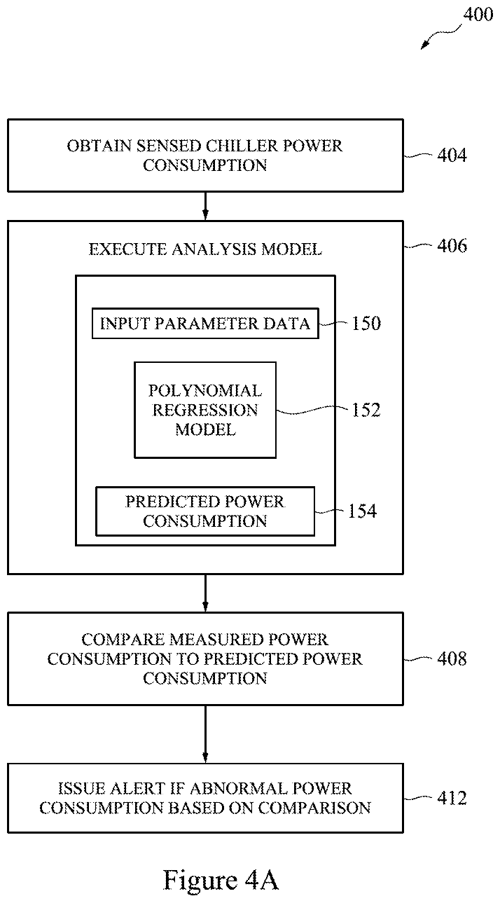

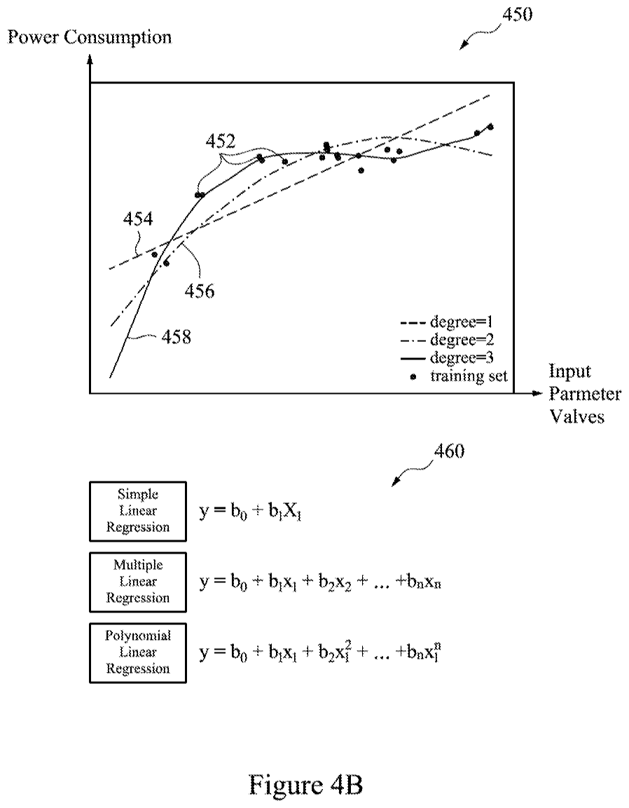

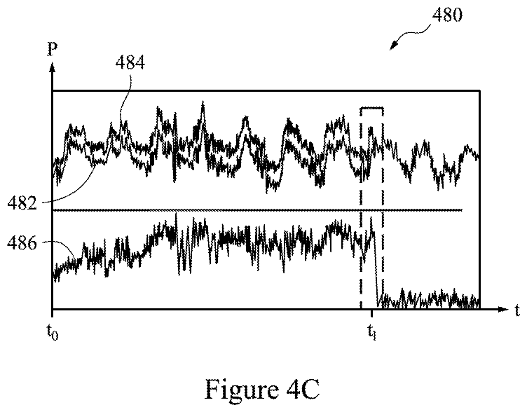

FIG. 4A is a flow diagram of a process 400 for operating a control system for a chiller system, in accordance with some embodiments. The process 400 can utilize systems, processes, and components described in relation to FIGS. 1-3. At 404, the process obtains the sensed chiller system power consumption. One example of a chiller system is the chiller system 101 of FIG. 1. This can correspond to measuring or otherwise sensing the total power consumption of a chiller system. However, it is possible that in some cases measuring or sensing equipment may malfunction. Furthermore, it is possible that a component such as the compressor may be functioning poorly or malfunctioning such that there is a greater total power consumption that will be expected based on current operating conditions of the chiller system.

At 406, an analysis model is executed. In the example of FIG. 3, the analysis model is a polynomial regression model 152. The polynomial regression model 152 is one example of an analysis model 105 of FIG. 1. The polynomial regression model can be previously trained as described in relation to FIG. 3, or based on another type of training process. Input parameter data 150 is provided to the polynomial regression model 152. In one example, the input parameters can include the refrigeration time, refrigerants fluid evaporation pressure, a refrigerants fluid condensing pressure, and a power consumption of the chiller compressor. The polynomial regression model processes the input parameters 152 and outputs a predicted power consumption 154.

In some embodiments, the input parameter data 150 can include other types of input parameters or other combinations of input parameters. The input parameters can include one or more of the refrigerant ton, the refrigerant fluid evaporation pressure, the refrigerant fluid condensing pressure, the power consumption of the chiller compressor, the temperature of the chilled water, the return temperature of the chilled water, the pressure of the chilled water, the flow rate of the chilled water, the temperature of the cooling water, the return temperature of the cooling water, the pressure of the cooling water, the flow rate of the cooling water, the temperature of outside air (e.g. the temperature of the air outside the cooling tower), the enthalpy of the outside air, the flow rate of the refrigerant fluid or other parameters.

FIG. 4A illustrates the analysis model as a polynomial regression model. However, the analysis model can include other types of analysis models. For example, the analysis model can include a neural network trained with a machine learning process, a decision trec network, a random forest model, or other types of analysis models. All such other analysis models fall within the scope of the present disclosure.

At 408, the process 400 compares the measured power consumption to the predicted power consumption. At 410, the process 400 outputs an alert if there is abnormal power consumption based on the comparison. For example, if the difference between the predicted power consumption and the measured power consumption is greater than a threshold difference, then the control system 103 can output an alert that a technician should perform maintenance on components of the chiller system. In one example, a chiller system can have an increase in power consumption of between 1900 and 2000 kWh per day. The threshold difference may be between 60 kWh and 80 kWh. Other parameters, thresholds, or processes can be utilized to determine whether or not an alert should be issued.

FIG. 4B, includes a graph 450 illustrating principles of the polynomial regression model, in accordance with some embodiments. The graph 450 illustrates a plurality of data points 452 from a training set. In particular, the x-coordinate of a point 452 corresponds to input parameter values and the y-coordinates of a point 452 corresponds to the power consumption. In practice, the input parameter values have a much more complex representation than shown in FIG. 4B. However, FIG. 4B helps to illustrate principles associated with polynomial regression models.

FIG. 4B also illustrates a plurality of equations 460 associated with various regression models. In the equations 460, the values “x” correspond to input parameter values. The values “b” correspond to weighting values that are learned during a machine learning process or a curve fitting process. The graph 450 corresponds to a polynomial linear regression model having a first curve 454 with a degree of one. The curve 456 corresponds to a polynomial linear regression model with a degree of two. The curve 458 corresponds to a polynomial linear regression model with a degree of three. As can be seen, the curve 454 fits the data points 452 most poorly. The curve 456 fits the data points 452 better than the curve 454. The curve 456 fits the data points 452 better than the curve 458. This illustrates that a higher degree results in a curve that benefits the training set data points 452. However, higher degrees utilized larger amounts of computing power. In one embodiment, a degree of two can be utilized for the polynomial regression model of FIG. 4A in other embodiments, a degree of three can be utilized for the polynomial regression model of FIG. 4A. Other degree values can be utilized without departing from the scope of the present disclosure.

FIG. 4C is a graph 480 illustrating predicted and measured power consumption of a chiller system, in accordance with some embodiments. A first curve 482 corresponds to a measured power consumption of a chiller system. A second curve 484 corresponds to a predicted power consumption of a chiller system. A third curve 486 corresponds to the difference between the measured power consumption and the predicted power consumption. Between times t0 and t1, the difference between the measured power consumption and the predicted power consumption increases. This may be the result of a faulty sensor of the chiller system. At about time t1, a technician of the chiller system has replaced the faulty sensor. Replacement of the faulty sensor results in the measured power consumption aligning with the predicted power consumption. Accordingly, issuing an alert indicating a difference larger than the threshold difference between the predicted power consumption and the measured power consumption can assist in quickly performing maintenance on or replacing failing equipment of the chiller system.

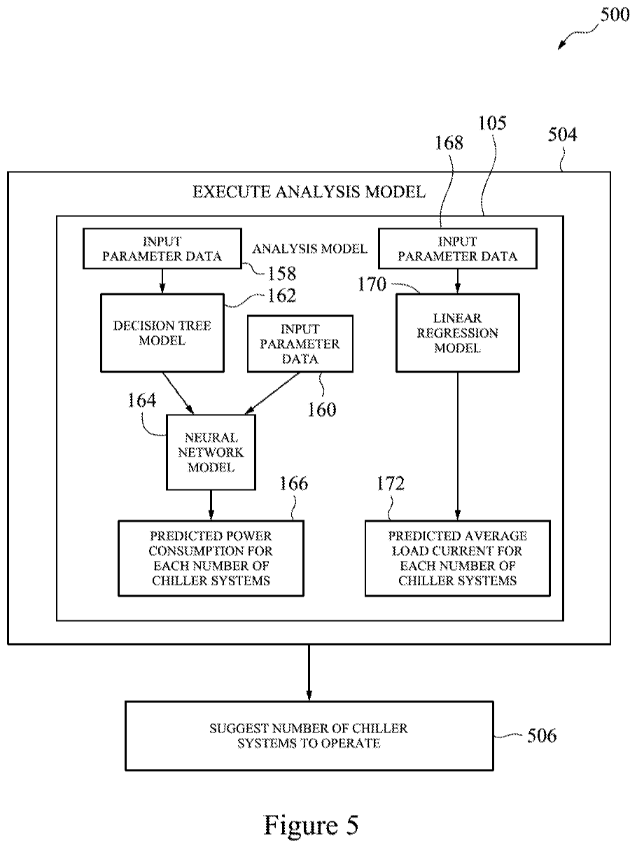

FIG. 5 is a flow diagram of a process 500 for operating a control system of a chiller system, in accordance with some embodiments. The process 500 can utilize systems, processes, and components described in relation to FIGS. 1-4C. 504, the process 500 executes an analysis model 105. The analysis model 105 is one example of an analysis model 105 of FIG. 1. The analysis model 105 includes three sub-models: a decision tree model 162, a neural network model 164, and a linear regression model 170. The analysis model 105 is utilized to determine a number of chiller systems that should be operated in parallel for reduced power consumption.

The decision tree model 162 and the neural network model 164 cooperate to generate predicted a power consumption 166 for each number of chiller systems. For example, if there are five available chiller systems, then the decision tree model 162 and the neural network model 164 can generate separate predicted power consumptions for one chiller system, two chiller systems, three chiller systems, four chiller systems, and five chiller systems.

The decision tree model 162 receives input parameter data 158. In some embodiments, the input parameter data 158 includes a number of operational chiller systems and a refrigeration ton associated with the load. The output of the decision tree model 162 can include the number of chiller systems or another type of data. The decision tree model 162 can be a simple and trained model or machine learning trained model. The output of the decision tree model is provided as an input parameter for the neural network model 164.

The neural network model 164 receives input parameter data 160 and the output of the decision tree model 162. In some embodiments, input parameter data 160 can include refrigeration ton, outside air enthalpy, chilled water supply temperature (T1), chilled water return temperature (T2), and chilled water flow rate. However, the neural network model 164 can also receive any of the other input parameters described previously such as various temperatures, pressures, and flow rates associated with a chiller system. The neural network 164 can be trained with a machine learning process to predict the power consumption for the various possible numbers of chiller systems.

The linear regression model 170 receives, as input data, the input parameter data 168. In some embodiments, the input parameter data 168 can include the number of running a chiller machines, the refrigeration ton, the outside air enthalpy, chilled water supply temperature (T1), the chilled water return temperature (T2), the chilled water flow rate, and the power consumption of the compressor. However, the linear regression model can also use other input parameters described herein as well as other combinations of input parameters. The linear regression model can be trained with a machine learning process or a curve fitting process, as described previously. The linear regression model 170 outputs a predicted average load current for each possible number of chiller systems.

In some embodiments, the analysis model 105 outputs the number of chiller systems that results in the lowest predicted power consumption. In some embodiments, the analysis model 105 outputs the number of chiller systems that results in the lowest predicted average load current. The analysis model 105 may output the number of chiller systems and results in both the lowest predicted average load current and the lowest predicted power consumption.

At 506, the process 500 suggests the number of chiller systems to operate. In some embodiments, the control system 103 outputs an alert to a technician indicating the suggested number of chiller systems to operate. The technician can then operate the control system 103 to activate a selected number of chiller systems. In some embodiments, the control system 103 automatically activates the suggested number of chiller systems. As used herein, activating the suggested number of chiller systems can include turning off or turning on selected chiller systems to reach the suggested number of operating chiller systems. Other types of analysis models 105 can be utilized for the process 500 without departing from the scope of the present disclosure.

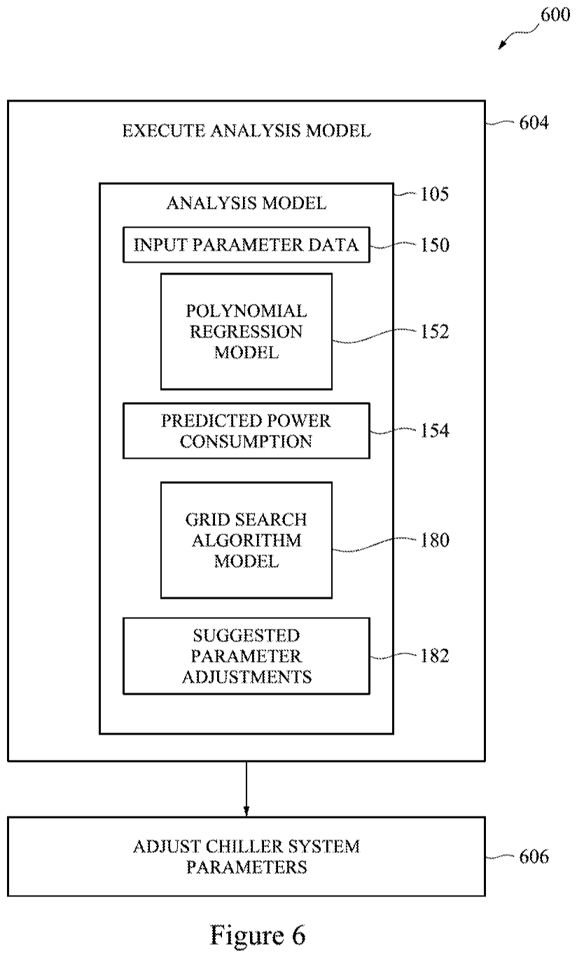

FIG. 6 is a flow diagram of a process 600 for operating a control system of a chiller system, in accordance with some embodiments. The process 600 can utilize systems, processes, and components described in relation to FIGS. 1-5. The process 600 generates a set of chiller system parameter adjustments predicted to result in reduced power consumption. At 604, the process 600 executes an analysis model 105. The analysis model 105 can include a polynomial regression model as described in relation to FIG. 4A. In particular, input parameter data 150 is provided to a polynomial regression model 152 the polynomial regression model outputs predicted power consumption 154. The input parameters 150 can include refrigeration ton, outside air enthalpy, chilled water supply temperature (T1), chilled water return temperature (T2), chilled water flow rate, power consumption of the compressor, the pressure difference at an end of the chilled water pipe 112, the temperature difference (T3−T4) of the cooling water, and the temperature of the cooling water. The input parameters 150 can also include other input parameters described herein and other combinations of input parameters.

The predicted power consumption 154 is fed to a grid search algorithm model 180. The grid search algorithm model 180 adjusts values of the input parameter data 150 and reads a new predicted power consumption 154 based on the adjusted input parameter data 150. The grid search algorithm model iteratively adjusts input parameter values until a lowest or reduced predicted power consumption 154 is output by the polynomial regression model 152. The grid search algorithm model 180 then output suggested parameter adjustments 182. The suggested parameter adjustments 182 can include suggested adjustments to one or more of the input parameters to result in the predicted lowest or reduced power consumption of the chiller system. In some embodiments, the suggested parameter adjustments can include adjustments to the pressure difference at an end of chilled water pipe 112, adjustments to the chiller water temperature (T1), adjustments to the temperature difference of the cooling water (T3−T4), or adjustments to the cooling water temperature (T3). Other parameter adjustments can be utilized, including various flow rate, pressure, and temperature adjustments to components of the chiller system, without departing from the scope of the present disclosure.

At 606, the process 600 adjusts the chiller system parameters in accordance with the suggested parameter adjustments 182. In some embodiments, the control system 103 automatically adjust chiller system parameters in accordance with the suggested parameter adjustments 182. In some embodiments, the control system 103 outputs an alert indicating the suggested parameter adjustments. A technician can then utilize the control system 103 to implement the suggested chiller system parameter adjustments. Other types of analysis models can be utilized in the process 600. For example, one or more neural networks, auto encoders, or other types of machine learning models can be utilized without departing from the scope of the present disclosure.

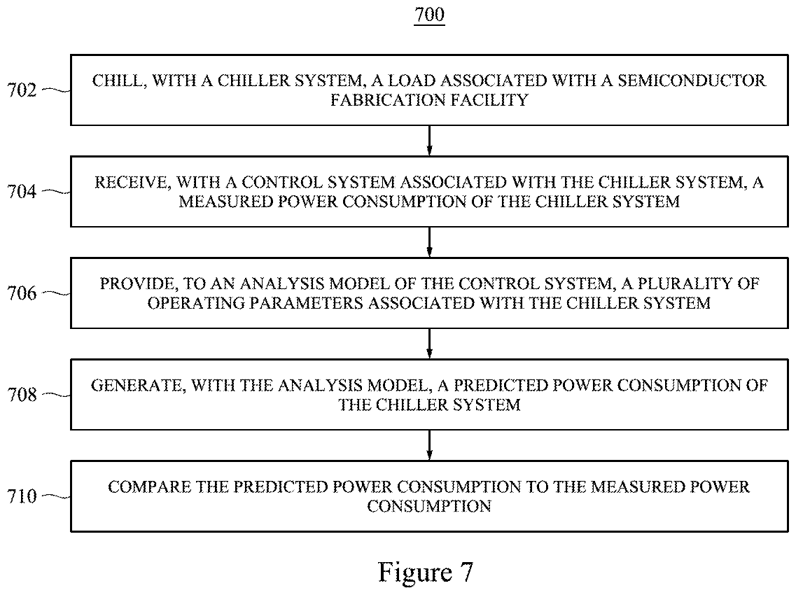

FIG. 7 is a flow diagram of a method 700, in accordance with some embodiments. The method 700 can utilize systems, components, and processes described in relation to FIGS. 1-6. At 702, the method 700 includes chilling, with a chiller system, a load associated with a semiconductor fabrication facility. One example of a chiller system is the chiller system 101 of FIG. 1. One example of a load is the load 108 of FIG. 1. At 704, the method 700 includes receiving, with a control system associated with the chiller system, a measured power consumption of the chiller system. One example of a control system is the control system 103 of FIG. 1. At 706, the method 700 includes providing, to an analysis model of the control system, a plurality of operating parameters associated with the chiller system. One example of an analysis model is the analysis model 105 of FIG. 1. At 708, the method 700 includes generating, with the analysis model, a predicted power consumption of the chiller system. At 710, the method 700 includes comparing the predicted power consumption to the measured power consumption.

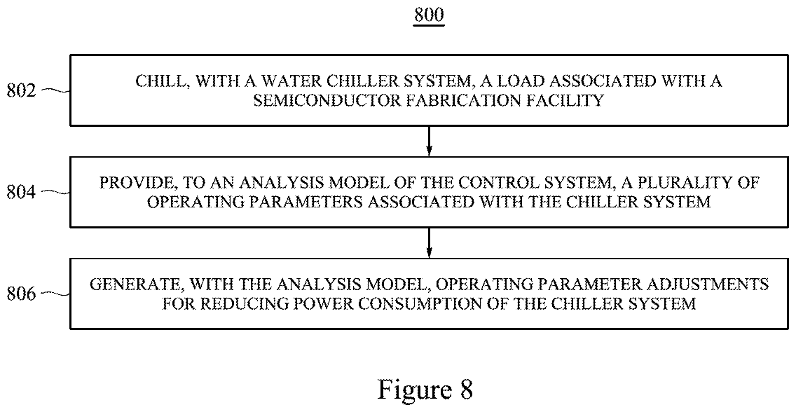

FIG. 8 is a flow diagram of a method 800, in accordance with some embodiments. The method 800 can utilize systems, components, and processes described in relation to FIGS. 1-7. At 802, the method 800 includes chilling, with a water chiller system, a load associated with a semiconductor fabrication facility. One example of a water chiller system is the chiller system 101 of FIG. 1. One example of a load is the load 108 of FIG. 1. At 804, the method 800 includes providing, to an analysis model of a control system, a plurality of operating parameters associated with the chiller system. One example of a control system is the control system 103 of FIG. 1. One example of an analysis model is the analysis model 105 of FIG. 1. At 806, the method 800 includes generating, with the analysis model, operating parameter adjustments for reducing power consumption of the chiller system.

In some embodiments, a method includes chilling, with a chiller system, a load associated with a semiconductor fabrication facility, receiving, with a control system associated with the chiller system, a measured power consumption of the chiller system, and providing, to an analysis model of the control system, a plurality of operating parameters associated with the chiller system. The method includes generating, with the analysis model, a predicted power consumption of the chiller system and comparing the predicted power consumption to the measured power consumption.

In some embodiments, a system includes a plurality of chiller systems each configured to be selectively activated for cooling a load and a control system communicatively coupled to the plurality of chiller systems. The control system includes one or more computer memories configured to store software instructions and one or more processors configured to execute the software instructions. Executing the software instructions performs a method includes receiving, at an analysis model of the control system, input parameters associated with the plurality of chiller systems, processing the input parameters with the analysis model, and determining, with the analysis model based on the input parameters, a number of the plurality of chiller systems to utilize in cooling the load.

In some embodiments, a method includes chilling, with a water chiller system, a load associated with a semiconductor fabrication facility, providing, to an analysis model of a control system, a plurality of operating parameters associated with the chiller system, and generating, with the analysis model, operating parameter adjustments for reducing power consumption of the chiller system.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method, comprising:
chilling, with a chiller system, a load associated with a semiconductor fabrication facility;
receiving, with a control system associated with the chiller system, a measured power consumption of the chiller system;
providing, to an analysis model of the control system, a plurality of operating parameters associated with the chiller system;
generating, with the analysis model, a predicted power consumption of the chiller system; and
comparing the predicted power consumption to the measured power consumption.

2. The method of claim 1, comprising outputting, with the control system, an alert if the predicted power consumption is different from the measured power consumption by more than a threshold difference.

3. The method of claim 2, wherein the alert indicates that maintenance should be performed on one or more components of the chiller system.

4. The method of claim 2, wherein the alert indicates that maintenance should be performed on a sensor associated with the chiller system.

5. The method of claim 2, wherein the input parameters include one or more of:
a refrigeration ton of the chiller system;
a refrigerant fluid evaporation pressure,
a refrigerant fluid condensing pressure; and
a power consumption of a compressor of the chiller system.

6. The method of claim 1, wherein the analysis model includes a polynomial regression model.

7. The method of claim 6, wherein the polynomial regression model has a degree of two or higher.

8. A system, comprising:
a plurality of chiller systems each configured to be selectively activated for cooling a load;
a control system communicatively coupled to the plurality of chiller systems and including:
one or more computer memories configured to store software instructions;
one or more processors configured to execute the software instructions, wherein executing the software instructions performs a method comprising:
receiving, at an analysis model of the control system, input parameters associated with the plurality of chiller systems;
processing the input parameters with the analysis model; and
determining, with the analysis model based on the input parameters, a number of the plurality of chiller systems to utilize in cooling the load.

9. The system of claim 8, wherein the analysis model includes a neural network trained with a machine learning process to generate a predicted power consumption for each number of chiller systems.

10. The system of claim 9, wherein determining the number of the plurality of chiller systems to utilize includes selecting the number of chiller systems that results in the lowest predicted power consumption.

11. The system of claim 9, wherein the analysis model includes a decision tree model coupled to the neural network model.

12. The system of claim 8, wherein the analysis model is configured to generate a predicted average load current for each number of chiller systems.

13. The system of claim 12, wherein determining the number of the plurality of chiller systems to utilize includes selecting the number of chiller systems that results in the lowest predicted average load current.

14. The system of claim 13, wherein the analysis model includes a linear regression model configured to generate the predicted average load current.

15. The system of claim 8, wherein the analysis model includes:
a neural network trained with a machine learning process to generate a predicted power consumption for each number of chiller systems; and
a linear regression model configured to generate a predicted average load current for each number of chiller systems.

16. The system of claim 15, wherein the method includes determining the number of the plurality of chiller systems to utilize in cooling the load based on the predicted power consumption for each number of chiller systems and the predicted average load current each number of chiller systems.

17. A method, comprising:
chilling, with a water chiller system, a load associated with a semiconductor fabrication facility;
providing, to an analysis model of a control system, a plurality of operating parameters associated with the chiller system; and
generating, with the analysis model, operating parameter adjustments for reducing power consumption of the chiller system.

18. The method of claim 17, comprising training the analysis model with a machine learning process.

19. The method of claim 17, comprising:
generating, with the analysis model, a first predicted power consumption of the chiller system based on the input parameters;
adjusting, with the analysis model, values of the input parameters;
generating, with the analysis model, a second predicted power consumption of the chiller system based on the adjust values; and
generating the operating parameter adjustments based on the second predicted power consumption.

20. The method of claim 17, wherein the operating parameter adjustments include a pressure difference adjustment for a chilled water pipe of the chiller system.
